(19) United States
(12) Patent Application Publication
(10) Pub. No.: US 2018/0242231 A1
(43) Pub. Date: Aug. 23, 2018

(54) ELECTRONIC TRANSCEIVER DEVICE, METHOD AND COMPUTER PROGRAM

(71) Applicant: Telefonaktiebolaget LM Ericsson (publ), Stockholm (SE)

(72) Inventors: Andres REIAL, Malmo (SE); Bengt LINDOFF, Bjarred (SE); Magnus ASTROM, Lund (SE)

(21) Appl. No.: 15/456,557

(22) Filed: Mar. 12, 2017

(30) Foreign Application Priority Data
Feb. 17, 2017 (EP) 17156708.4

(51) Int. Cl. H04W 48/16; H04W 72/04; G06N 5/04

(52) U.S. Cl. CPC H04W 48/16; G06N 5/04; H04W 72/0406

(57) ABSTRACT

An electronic transceiver device is arranged to operate in a cellular communication system, where the cellular communication system has a network node arranged to transmit control information by sweeping a cell with multiple consecutive beams where each beam covers a part of the cell and repeats at least a part of the control information. The electronic transceiver device comprises a receiver arranged to receive signals from the network node, wherein the receiver is configured to receive a first signal from a first beam and a second signal from a second beam of the beams provided by the network node; a memory arranged to store at least information received in the first signal; and a signal processor arranged to form hypotheses of differences in the received information of the first and second signals for soft-combining the information of the first and second signals; and upon a hypothesis indicating successful soft-combining of the first and the second signals, decode control information carried by the first and second signals. A method and computer program for the electronic transceiver device are also disclosed.

### TECHNICAL FIELD

The present invention generally relates to an electronic transceiver device and method and computer program therefor. In particular, the present invention relates to soft-combining of signals provided in sweeping beams from a network node.

### BACKGROUND

When an electronic transceiver device, such as User Equipment (UE), wishes to connect to a wireless cellular communication system, for example after power-on or when waking up after an extended sleep period, it goes through an initial-access procedure. The first step of this procedure is typically that the electronic transceiver device searches for and detects a synchronization signal that is regularly broadcast by the network access nodes. After successful time-frequency alignment, the electronic transceiver device may listen for additional information from the network, e.g. so-called system information, and/or respond with a request to join the network. This is often referred to as physical random access channel message, or Physical Random Access Channel (PRACH) message). The electronic transceiver device is typically not allowed to send the request to join at an arbitrary time, since that could conflict with other transmissions in the system, but should rather send it at a predefined time interval after the downlink signal was received.

One possible initial access sequence is depicted in FIG. 12. The electronic transceiver device detects a signature sequence (SS) signal that provides at least synchronization, and an associated system information block (MIB) that together with the SS provides essential system info for accessing the system via the PRACH procedure. The received SS+MIB can be used to as an index to retrieve additional system information from an access information table (AIT) or other system broadcast transmission.

Cellular systems may use advanced antenna systems containing large antenna arrays for data transmission. With such antenna arrays, data signals may be transmitted in narrow beams to increase signal strength in some directions, and/or to reduce interference in other directions. On the one hand, this is done to obtain improved link quality and to enable spatial separation and reduce interference between users. On the other hand, using arrays is necessary to ensure sufficient link quality in high-frequency deployments where the individual antenna element apertures are small and do not capture sufficient signal energy individually. Coherently aligning the antenna elements gives rise to effective beam gain, but also beam directivity in a certain direction.

While usage of large arrays with beamforming is usually viewed as a desirable phenomenon when transmitting data between an access node and a specific electronic transceiver device, it complicates broadcast system information distribution. In some cases, even if it is possible to configure broad beams from large arrays, the signal strength at the electronic transceiver device may be insufficient and long-term coherent accumulation may be needed. The extent of such accumulation is limited by electronic transceiver device local oscillator stability and channel coherence time.

Therefore, the broadcast info, e.g. AIT, Physical Broadcast Channel (PBCH), Secondary Physical Broadcast Channel (SPBCH), MIB, and SS, such as Primary Synchronization Signal (PSS) and Secondary Synchronization Signal (SSS), may be transmitted using beam sweeping, at least in higher-frequency deployments. According to the expected solution, the broadcast information may be transmitted in one or more orthogonal frequency division multiplex (OFDM) symbols per beam, where a main lobe angle steps through a set of predetermined values, e.g. φ(n) in symbol or symbol group n, φ(n+1) in symbol or symbol group n+1 etc. Depending on the type of broadcast information, some or all information bits in the subsequent symbols representing different beams may be the same, or some of them may differ. One example of embedding varying information is the inclusion of a count-down counter in the SS+MIB transmission to indicate the time to a PRACH transmission window. In that case, a counter value is reduced in each OFDM symbol, while the node identity and/or access format information does not change.

During the sweep, when the access node steps through a set of narrow beam directions, not every electronic transceiver device is located in the centre of their respective best beam. For electronic transceiver devices that end up off-centre in their best beam, the straddling loss may be up to 2-4 dB, depending on the spatial oversampling used in the sweeping process. Some electronic transceiver devices near the cell border and in-between two beams may therefore experience worse coverage and may be unable to receive the system information.

The system information broadcast is periodic, so the electronic transceiver device could attempt detecting the information again at a later time, e.g. 100 ms later, and possibly combine the several reception instance non-coherently or semi-coherently. However, the delay associated with awaiting an additional broadcast information transmission may be prohibitive in many scenarios.

The straddling loss leads to an uneven system information coverage area, which in practice means that the planned cell radius may be reduced or that cell deployment will become more complicated, defining uneven cell border areas.

Hence there is a need for a method for improving system information detection performance in such scenarios

### SUMMARY

The invention is based on the understanding that a sweeping beam from a network node may provide variable range at cell borders depending on whether an electronic transceiver device happen to be in the direction of a beam or slightly beside it. Here, the sweeping of beams means providing, consecutively in time, multiple beams each covering a part of the cell. The inventors have found that by attempting to soft-combine signals from adjacent beams in the latter case, the range can in practice be less varying.

According to a first aspect, there is provided an electronic transceiver device arranged to operate in a cellular communication system, where the cellular communication system has a network node arranged to transmit control information by sweeping a cell with multiple consecutive beams where each beam covers a part of the cell and repeats at least a part of the control information.

The electronic transceiver device comprises a receiver arranged to receive signals from the network node. The receiver is configured to receive a first signal from a first beam and a second signal from a second beam of the beams provided by the network node.

The electronic transceiver device further comprises a memory arranged to store at least information received in the first signal, and a signal processor. The signal processor is arranged to form hypotheses of differences in the received information of the first and second signals for soft-combining the information of the first and second signals, and upon a hypothesis indicating successful soft-combining of the first and the second signals, decode control information carried by the first and second signals. The soft-combining may include soft-combining the signals per se or state information and branch metrics associated with the signals. The indication on successful soft-combining may be based on attempted decoding or observing the progress of state information and branch metrics.

The signal processor may be arranged to, prior forming the hypotheses, decode control signals carried by any of the first and second signals, and wherein upon successful decoding of the control signals carried by any of the first and second signals, the signal processor may be arranged to omit forming the hypotheses, and upon unsuccessful decoding of the control signals carried by any of the first and second signals, the signal processor may be arranged to proceed with forming the hypotheses, the soft-combining of signals, and the decoding of control information. The determination of successful decoding may be based on a check sum, e.g. cyclic redundancy check (CRC).

The multiple consecutive beams may be repeatedly sweeping the cell, and the memory and signal processor may be arranged to only consider beams within a last repetition cycle. The repetition cycle may for example be the same as the broadcast period, e.g. 100 ms.

The sweeping may be performed in one plane, wherein the memory and signal processor may be arranged to consider the first and second signals from two mutually adjacent beams. Alternatively, the sweeping is performed in two planes, wherein the memory may be arranged to store information received in a plurality of signals, and the signal processor may be arranged to form hypotheses of differences in the information received in the plurality of signals, respectively, and the second signal for soft-combining the information of at least one of the plurality of signals and the second signal. Here, performing sweeping in one plane can be considered to sweep over two coordinates in for example a Cartesian or polar coordinate system, while performing the sweeping in two planes can be considered to sweep over three coordinates of for example a Cartesian, cylindrical or spherical coordinate system.

The signal processor may be arranged to form the hypotheses by being configured to hypothesize a difference between the first signal or one of the plurality of signals and the second signal, the difference being one or more symbols of the first signal or one of the plurality of signals differing from corresponding symbols of the second signal, and decode the first signal or one of the plurality of signals. The decoding may be performed by, for each code word segment of a received first code word of the first signal or one of the plurality of signals, determining a first metric associated with a probability that the code word segment of the received first code word corresponds to a first signal segment content, determining a second metric associated with a probability that the code word segment of a received second code word of the second signal corresponds to the first signal segment content conditional on the difference between the first signal or one of the plurality of signals and the second signal, and determining a decision metric from the first and second metrics. The signal processor may be arranged to select, for the first signal or one of the plurality of signals, the first signal segment content or a second signal segment content, or for the second signal the first signal segment content or the second signal segment content, based on the decision metric, for the soft-combining, wherein a determination whether the soft-combining is successful is based on the decision metric.

The signal processor may be arranged to form the hypotheses of differences in the received information of the first and second signals for soft-combining the information of the first and second signals by being arranged to invert and soft-combine the information according to a hypothesis dependent pattern. The hypothesis dependent pattern may be chosen based on the nature of the first and second signals. The nature of the first and second signals may include known positions of information bits that change between the first and second signals. Furthermore, the hypothesis dependent pattern may be adapted based on actual circumstances. For example, the hypothesis dependent pattern may be adapted based on difference in timing, e.g. counted in symbol periods, between the signals.

According to a second aspect, there is provided a method of an electronic transceiver device arranged to operate in a cellular communication system. The cellular communication system has a network node arranged to transmit control information by sweeping a cell with multiple consecutive beams where each beam covers a part of the cell and repeats at least a part of the control information. The method comprises receiving signals from the network node, including receiving a first signal from a first beam and receiving a second signal from a second beam of the beams provided by the network node, storing at least information received in the first signal, forming hypotheses of differences in the received information of the first and second signals for soft-combining the information of the first and second signals, and decoding, upon a hypothesis indicating successful soft-combining of the first and the second signals, control information carried by the first and second signals.

The method may comprise, prior forming the hypotheses, decoding control signals carried by any of the first and second signals, and wherein upon successful decoding of the control signals carried by any of the first and second signals, omitting the forming of the hypotheses, and upon unsuccessful decoding of the control signals carried by any of the first and second signals, proceeding with forming the hypotheses, the soft-combining, and the decoding. The determination of successful decoding may be based on a check sum.

The multiple consecutive beams may be repeatedly sweeping the cell, and the first and the second signals may be included in beams within a last repetition cycle.

The sweeping may be performed in one plane, and the first and second signals may emanate from two mutually adjacent beams. Alternatively, the sweeping may be performed in two planes, wherein the storing may include storing information received in a plurality of signals, and the forming of hypotheses may include forming of hypotheses of differences in the information received in the plurality of signals, respectively, and the second signal for soft-combining the information of at least one of the plurality of signals and second signal.

The forming of hypotheses may comprise hypothesizing a difference between the first signal or one of the plurality of signals and the second signal, the difference being one or more symbols of the first signal or one of the plurality of signals differing from corresponding symbols of the second signal, decoding the first signal or one of the plurality of signals, and selecting a signal segment. The decoding may be performed by, for each code word segment of a received first code word of the first signal or one of the plurality of signals determining a first metric associated with a probability that the code word segment of the received first code word corresponds to a first signal segment content, determining a second metric associated with a probability that the code word segment of a received second code word of the second signal corresponds to the first signal segment content conditional on the difference between the first signal or one of the plurality of signals and the second signal, and determining a decision metric from the first and second metrics. The selecting may include selecting, for the first signal or one of the plurality of signals, the first signal segment content or a second signal segment content, or for the second signal the first signal segment content or the second signal segment content, based on the decision metric, for the soft-combining, wherein a determination whether the soft-combining is successful is based on the decision metric.

The forming of the hypotheses of differences in the received information of the first and second signals for soft-combining the information of the first and second signals may comprise inverting and soft-combining the information according to a hypothesis dependent pattern.

According to a third aspect, there is provided a computer program comprising instructions which, when executed on a processor of an electronic transceiver device, causes the electronic transceiver device to perform the method according to the second aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 schematically illustrates an electronic transceiver device according to an embodiment.

FIG. 2 is an illustration of a network node of a cellular communication system arranged to transmit control information by sweeping a cell with multiple consecutive beams where each beam covers a part of the cell and repeats at least a part of the control information.

FIG. 3 is a top view of a network node 300 which provides beams with range r in different directions φ to sweep the coverage area of the network node.

FIG. 4 is a schematic illustration of a network node providing a first beam and a second beam.

FIG. 5 is a coverage diagram schematically illustrating coverage of a network node applying a sweeping beam.

FIG. 6 is a coverage diagram schematically illustrating coverage of a network node applying a sweeping beam with application of soft-combining.

FIG. 7 is a side view of a network node which provides the beams with range r with different elevations θ to sweep the coverage of the network node also elevation-wise.

FIG. 8 is a flow chart illustrating a method according to an embodiment.

FIG. 9 is a flow chart illustrating a method according to an embodiment.

FIG. 10 is a flow chart illustrating forming and evaluating of a hypotheses according to an embodiment.

FIG. 11 schematically illustrates a computer-readable medium and a processing device.

FIG. 12 is a timing diagram schematically illustrating an initial access sequence.

### DETAILED DESCRIPTION

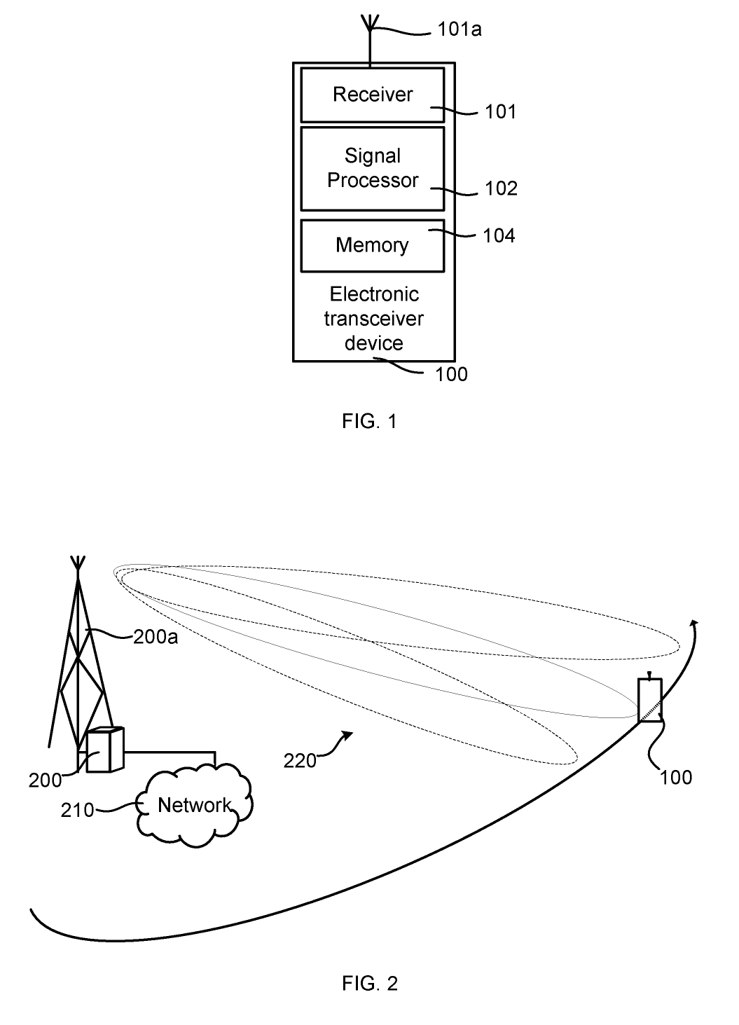

FIG. 1 schematically illustrates an electronic transceiver device 100 according to an embodiment. The electronic transceiver device 100. The electronic transceiver device 100 may be a User Equipment (UE), smart phone, modem, laptop, Personal Digital Assistant (PDA), tablet, mobile terminal, smart phone, laptop embedded equipped (LEE), laptop mounted equipment (LME), Universal Serial Bus (USB) dongles, machine type UE, UE capable of machine-to-machine (M2M) communication, etc., or a sensor or actuator is able to wirelessly send and receive data and/or signals to and from a network node. The electronic transceiver device 100 comprises a transceiver which at least comprises a receiver 101 connected to an antenna arrangement 101a to be able to receive signals transmitted from a network node of a cellular communication system. The network node is arranged to transmit control information by sweeping a cell with multiple consecutive beams where each beam covers a part of the cell and repeats at least a part of the control information. Such a network node is further demonstrated with reference to FIG. 2. The electronic transceiver device 100 further comprises a signal processor 102 and a memory 104. The electronic transceiver device 100 may comprise further elements for fulfilling tasks usually existing in any of the example devices demonstrated above, such as user interface, signal interfaces, power circuits, etc., but since this is commonly known features and not influencing the invention, a further discussion thereabout is not provided not to obscure the main contribution of this disclosure.

The receiver 101 is arranged to receive signals from the network node, which provides the beams, each covering a part of the cell and repeating at least a part of the control information. When the electronic transceiver device 100 is on a distance from the network node where the beams are close to their maximum range, the electronic transceiver device may be between two beams, i.e. at a position where the electronic transceiver device 100 is not able to decode the signal from either of the beams. The coverage, seen in an ideal environment from a two-dimensional perspective, will thus look like illustrated in FIG. 5.

The receiver 101 is configured to receive a first signal from a first beam and a second signal from a second beam of the beams. Considering FIG. 4, which is a schematic illustration of a network node 400 providing a first beam 402 and a second beam 404. It is to be noted that the two beams 402, 404 are not transmitted simultaneously. An electronic transceiver device in the area 406 scotch marking will encounter the problem elucidated in the previous paragraph. However, if the electronic transceiver device receives both the first signal and the second signal, even if it cannot decode either of them, but applies hypotheses for soft-combining the information gathered from the two beams, and upon successful soft-combining, the electronic transceiver device will be able to decode a control signal within at least a part of the area 406. Ideally, the coverage by the network node will then, with similar assumptions as for FIG. 5, look like illustrated in FIG. 6.

Since the beams are transmitted at different times, the electronic transceiver device comprises a memory 104 arranged to store at least information received in the first signal, i.e. such that the information is remembered until the second beam is received. Of course, both the first and the second signals may be stored, and the processing demonstrated below will then operate on the information about both the beams from the memory 104.

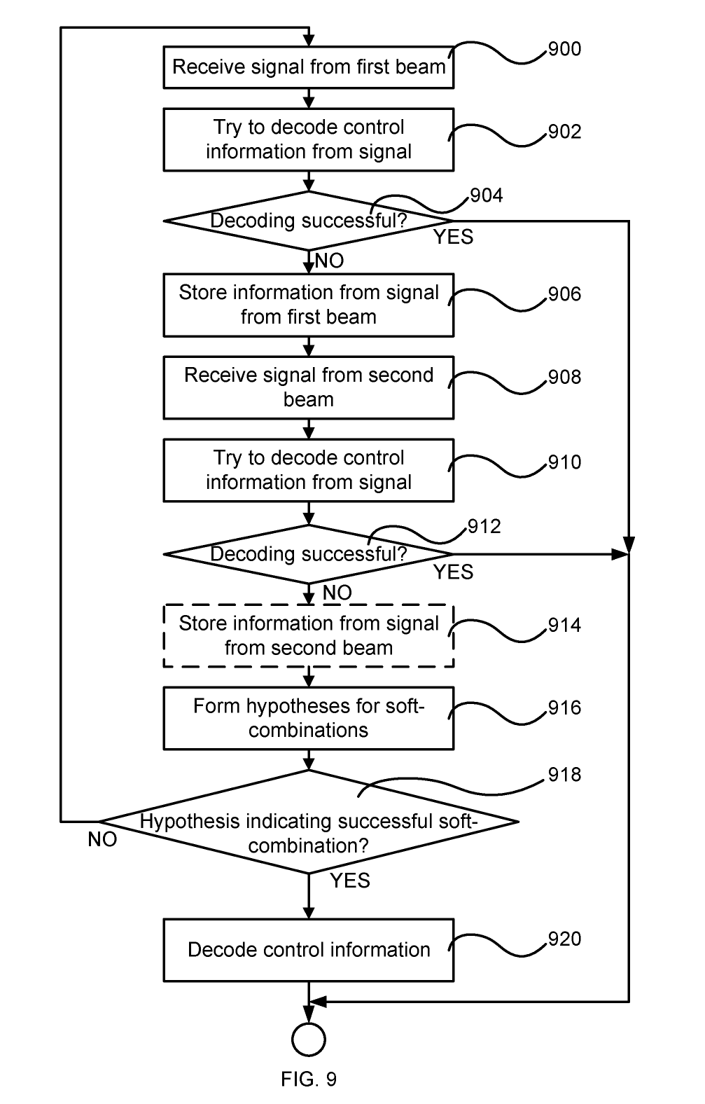

To be able to do the soft-combining, the electronic transceiver device comprises a signal processor 102. The signal processor 102 is arranged to interact with the memory to be able to operate on stored information which has been extracted from previous beam(s). The signal processor 102 is arranged to form hypotheses of differences in the received information of the first and second signals for soft-combining the information of the first and second signals. The processing is further demonstrated with reference to FIGS. 8 and 9, where methods of the electronic transceiver device 100 are elucidated. Thus, upon a hypothesis indicating successful soft-combining of the first and the second signals, the electronic transceiver device 100 is able to decode control information carried by the first and second signals.

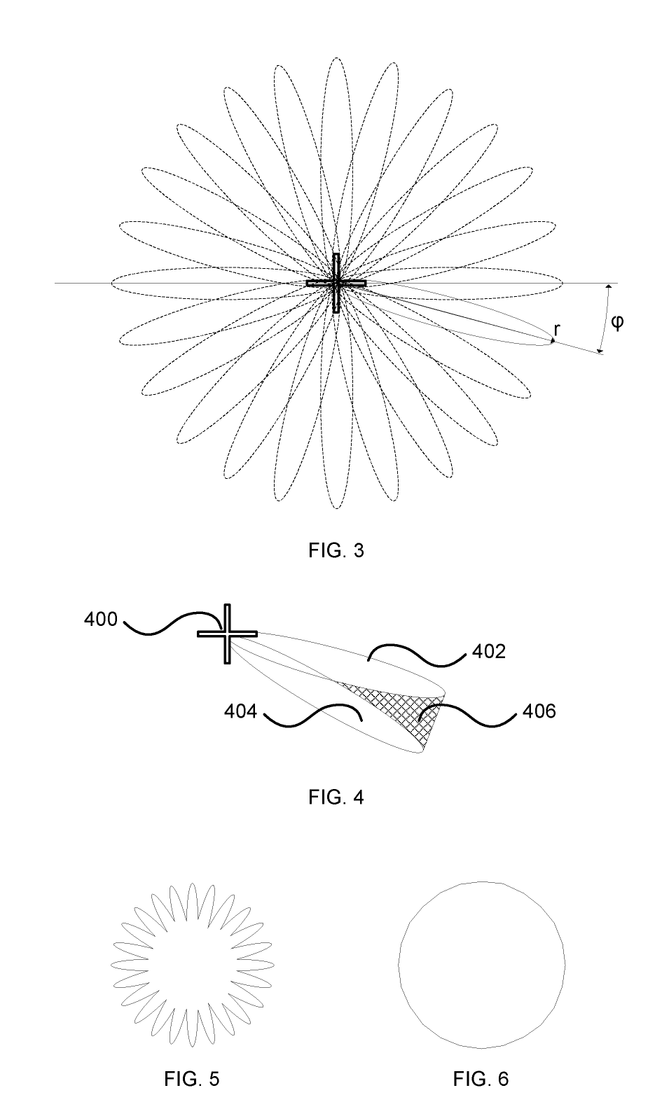

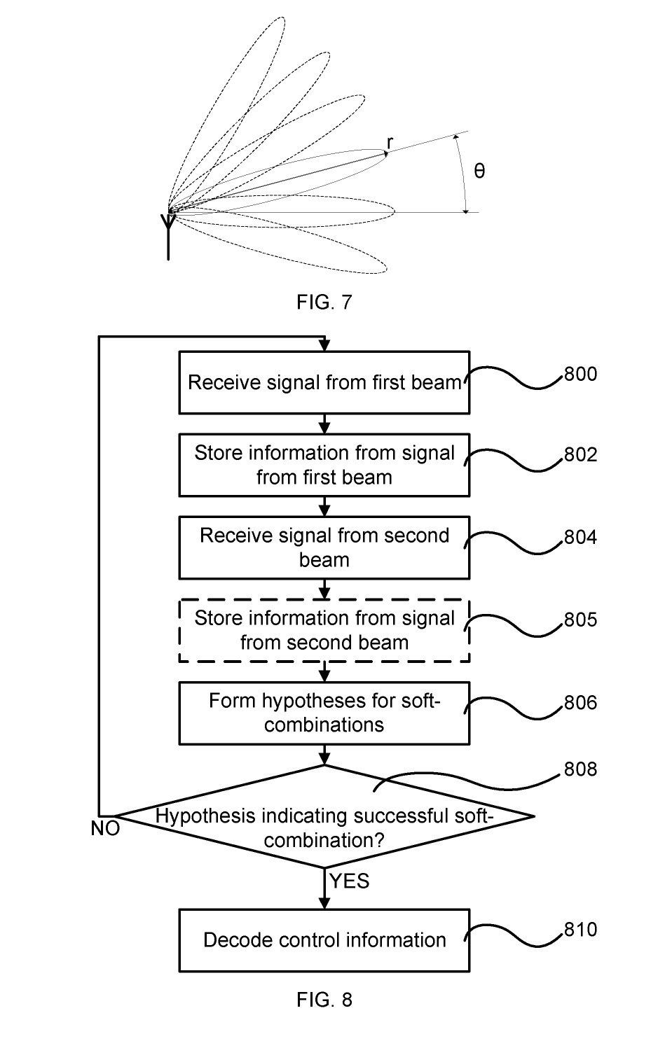

FIG. 2 is an illustration of a network node 200 of a cellular communication system. The network node 200 is connected to a network 210 which is arranged to provide backhaul for the network node 200. The network node 200 is arranged to transmit, through an antenna arrangement 200a, control information by sweeping a cell with multiple consecutive beams 220 where each beam covers a part of the cell and repeats at least a part of the control information. For the sake of simplicity, only the main lobe of the beam is depicted since that is the one which plays a role in this disclosure. The antenna arrangement 200a is arranged to form the beams under control of the network node 200 such that the beams 220 each has a certain direction in relation to the antenna arrangement 200a. For example, the antenna arrangement 200a may be a phased array antenna where antenna elements of the array are provided with controlled signals such that signals at particular angles experience constructive interference while others experience destructive interference to achieve the directional features of the respective beam. The sweeping may be performed in one plane, i.e. beams are consecutively provided around the antenna arrangement 200a or in a sector from the antenna arrangement 200a where each beam covers a subsector of the intended coverage area of the network node 200. The sweeping may also provide sweeping elevation-wise, i.e. in two planes. This may for example be achieved using one or more planar array antennas where directional beam control is achieved by varying the relative phase of each antenna element of the antenna array. Here, performing sweeping in one plane can be considered to sweep over two coordinates in for example a Cartesian or polar coordinate system, while performing the sweeping in two planes can be considered to sweep over three coordinates of for example a Cartesian, cylindrical or spherical coordinate system. Here, application in the polar and spherical coordinate systems, respectively, provide the easiest understanding of the beam sweeping, as illustrated in FIGS. 3 and 7.

The choice of sweeping pattern may be selected depending on the surroundings of the network node 200. For example, in a rural area where coverage on the ground is desired, the sweeping in one plane may be preferred, while in an urban area where coverage also is desired in tall buildings, the sweeping in two planes may be preferred. For network nodes which have a demand on providing coverage for airborne electronic transceiver devices, the sweeping in two planes may also be preferred. A further consideration is what abilities there are to form the beams to be fairly wide elevation-wise while still keeping them with a narrow subsector and reach far enough, and when that is feasible, the sweeping may be kept in one plane to achieve the desired coverage. Sweeping in the different directions is further discussed with reference to FIGS. 3 and 7. FIG. 3 is a top view of a network node 300 which provides beams with range r in different directions φ to sweep the coverage area of the network node 300. It is to be noted that the beams are not transmitted simultaneously, but consecutively such that the area is scanned, which is illustrated by only one of the beams in FIG. 3 is drawn with solid line.

It is to be noted that the illustration of FIG. 3 shows sweeping in one plane. However, the sweeping may include two planes, i.e. the 3-dimensional space. This is achieved by also sweeping elevation-wise. FIG. 7 is a side view of a network node 700 which provides the beams with range r with different elevations θ to sweep the coverage of the network node 700 also elevation-wise. It is to be noted that the beams are not transmitted simultaneously, but consecutively such that the area is scanned, which is illustrated by only one of the beams in FIG. 7 is drawn with solid line. It is also to be noted that the variation in elevation θ for sweeping elevation-wise is combined with sweeping in the different azimuth directions φ as of FIG. 3.

FIG. 8 is a flow chart illustrating a method for an electronic transceiver device according to an embodiment. A first signal from a first beam is received 800.

Information acquired from the first signal of the first beam is stored 802. A second signal from a second beam is received 804. The second beam is reasonably spatially adjacent to the first beam, but need not be consecutive in time with the first beam depending on a chosen pattern in which the consecutive beam provision is performed. Information acquired from the second signal may also be stored 805 such that processing can be made at an arbitrary time instant. The processing includes forming 806 hypotheses for soft combining of information from the first and the second signals or their decoder representations, i.e. states and branch metrics. If a hypothesis is formed that indicates 808; YES successful soft-combination, the desired control information is decoded 808 therefrom. If no successful soft combination is indicated 808; NO, the electronic transceiver device continues receiving signals from beams, and the above demonstrated procedure is repeated. Here, the indication on successful soft-combining may, as discussed above, be based on attempted decoding or observing the progress of state information and branch metrics. The soft-combining may include soft-combining the signals per se or state information and branch metrics associated with the signals.

FIG. 9 is a flow chart illustrating a method for an electronic transceiver device according to an embodiment. While the embodiment demonstrated with relation to FIG. 8 makes the assumption that the wireless transceiver device operates at a spot where information from a single beam is not sufficient for proper decoding of control information, the embodiment to be demonstrated with reference to FIG. 9 does not make that assumption. Thus, when a first signal is received 900 from a first beam, the wireless transceiver device tries to decode 902 the control information from the first signal. If the decoding is successful 904; YES, e.g. based on a check sum for determination of successful decoding, the desired control information is acquired and the task is fulfilled. However, if the decoding is not successful 904; NO, information from the first signal is stored 906. A second signal from a second beam is received 908, and similar to what is described above, the wireless transceiver device tries to decode 910 the second signal, and if decoding of the second signal is successful 912; YES, the task is fulfilled, but if also the attempt to decode the second signal is not successful 912; NO, the similar approach as demonstrated with reference to FIG. 8 is applied. Thus, information from the second signal may be stored 914 to enable processing at arbitrary time, and hypotheses are formed 916 for soft-combining of information from the first and second signals. If a hypothesis indicating successful soft-combining is found 918; YES, the desired control information is decoded 920 therefrom, and if no hypothesis indicating successful soft-combining of the first and second signals, the procedure continues with receiving further signals from further beams.

Here, the optional actions of storing 805, 914 information from the second signals to enable processing at arbitrary time provides for enabling the wireless transceiver device to continue receiving signals from further beams simultaneous with processing already received signals. Thus, the sequential nature illustrated by the flow charts should be interpreted accordingly, i.e. receiving steps 800, 804, 900, 908 may be repeated before or simultaneous with the processing of previously received signals. That is, the methods may be performed on a real-time basis rather than sequentially as inherently showed by a flow chart.

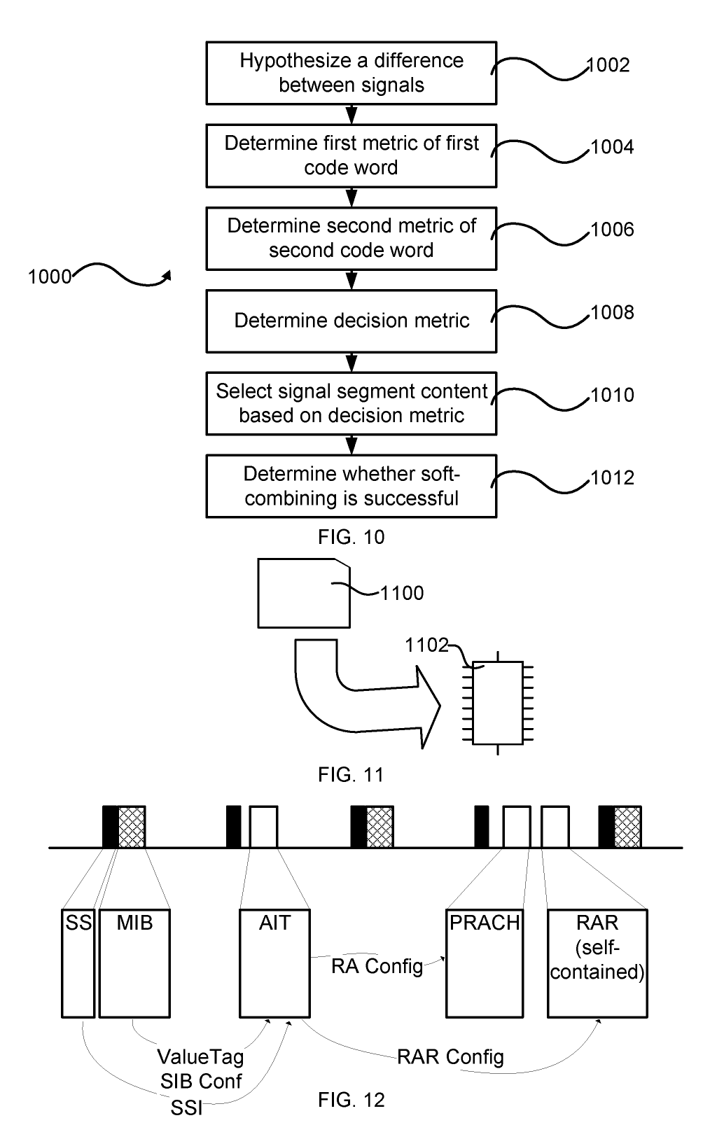

For the sake of easier understanding, the forming of hypotheses and decoding has in FIGS. 8 and 9 been illustrated on a rough level. The skilled reader will understand that the decoding is interleaved with the forming and evaluation of the respective hypotheses. The actual forming of the hypotheses and evaluation thereof may for example rely on statistical parsing, e.g. utilizing a Viterbi algorithm for achieving a maximum-likelihood performance. FIG. 10 is a flow chart schematically illustrating forming and evaluating 1000 of a hypothesis. That is, the processing steps 806-810, 916-920 as demonstrated above may for example be performed as demonstrated for the forming and evaluating 1000.

A difference between the first and second signals is hypothesized 1002. The difference is one or more symbols of the first signal differing from corresponding symbols of the second signal. Metrics for different possible code words are determined, i.e. a first metric of a first code word is determined 1004 and a second metric of a second code word is determined 1006. Here, for the sake of simplicity and easier understanding of the text, the terms “first metric” and “second metric” are used, but they may each comprise a set of one or more metrics. The first metric is associated with a probability that the code word segment of the received first code word corresponds to a first signal segment content. The second metric may be associated with a probability that the code word segment of a received second code word of the second signal corresponds to the first signal segment content conditional on the difference between the first signal and the second signal. A decision metric is determined 1008, wherein signal segment content is selected 1010 based on the decision metric. The decision metric may be acquired by observing the first and second metrics for respective path, i.e. the decision metric is given by the algorithm, e.g. by a Viterbi decoder, for the path. According to some embodiments, the second metric may be determined 1006 independently of the first metric, wherein the decision metric is determined 1008 over combinations of the first and second metrics, i.e. for feasible transition likelihoods. The signal segment content is selected, based on the decision metric, among, for the first signal, the first signal segment content or a second signal segment content, or for the second signal the first signal segment content or the second signal segment content, for the soft-combining. It is then determined 1012 whether the soft-combining is successful based on the decision metric. For multi-dimensional spatial beam sweeping, i.e. in two planes, the forming and evaluating 1000 of hypotheses may be performed on a plurality of signals, on which information may have been stored, i.e. not just the first signal, but the principle above still applies.

The above is based on an approach for decoding of codes that may be represented via a state machine. The approach is particularly useful when decoding two code words with a hypothesized, e.g. known, difference. For example, the approach may include joint Viterbi decoding of blocks, i.e. code words, with unknown content but known difference, but is not limited to a Viterbi decoder. For example, a modification of the Viterbi decoder that allows joint decoding of code blocks (i.e. code words) containing the same unknown information may be used, but where it is known that some symbols, e.g. bits, at known positions are toggled, e.g. flipped from 0 to 1, and vice versa. This allows the desired control information to be decoded using blocks from different, e.g. adjacent, beams. Hence, redundancy can be achieved by collecting blocks from multiple beams. The branch metrics for the two or more jointly decoded blocks, i.e. code words, may be combined in a manner that takes the toggled bits into account. Typically, each control signal instance is decoded separately, but the decisions on the most likely path through each respective trellis is based on the combined information from all jointly decoded blocks.

Each state of the Viterbi decoder represents the most recent bits in the code block. It is realized that by concatenating a toggle bit pattern and an associated check sum, every state in the decoding of the second code block to the corresponding state in the decoding of the first code block. This allows the so called path metrics, which is a central concept of the Viterbi algorithm and which is to be minimized or maximized, depending on the type of metric used in the decoding, in order to find the transmitted message with maximum likelihood, to be combined when deciding which previous nodes to select as inputs to the current ones.

A Viterbi algorithm typically contains the following elements:
A Path Metrics Unit (PMU), dynamically connecting nodes, i.e. states for different output bits, and
A Traceback Unit (TBU), converting a sequence of state transitions into binary 0s and 1s or a soft representation thereof.
The PMU further comprises:
A Branch Metrics Unit (BMU), where given a received code word segment and a particular node, i.e. state, and two branching words, each associated with a separate next node, i.e. subsequent state, a cost in terms of distance between the received code word segment and a branch word is calculated, where distance may refer to any of the non-limiting examples:
   Hamming distance, in case of ‘hard’ decoding where input to algorithm is binary values, or
   Euclidean distance, in case of ‘soft’ decoding where input to algorithm is mapped to values in, for instance, the range [0,7], where 0 is a strong binary 0 and 7 is a strong binary 1, and where 3 and 4 are weak 0s and 1s, respectively
An Add-Compare-Select Unit (ACS), where path metric is calculated for each of the potential input nodes (previous states, in this example there are up to two potential input nodes) to each node (state) representing a next node (subsequent state) wherein for each potential input the path metric at that particular node (previous state) is added to the branch metric for transition from that particular node to this next node (subsequent state); where calculated path metrics are compared; and where the input node associated with the smallest path metrics is selected as the input node to this particular next node.

The inputs to the algorithm are two code blocks, i.e. first and second code words, and a toggle pattern, i.e. a difference, known or at least hypothesized.

For each pair of received code word segments a state-toggle mask may be defined based on the input toggle pattern, where bits are read out, e.g. by a modulo operation, and where the MSB (most significant bit) is the left-most bit.

In the ACS unit, path metrics (first and second metrics) are calculated and maintained independently of each other for the two code blocks, but when comparing and deciding which input to take, the metrics are combined, e.g. added, over the nodes to produce a decision metric.

Depending on the state-toggle pattern for the previous code word segment, the order of the path metrics for the two potential input nodes may have to be shifted for metrics related to the second code block before adding them to corresponding metrics for the first code block.

For each node, the input node associated with the smallest path metrics is selected.

Generally, decoding may be achieved using any suitable approach or algorithm for decoding of state machine representable codes. For example, the decoding approach may apply trellis decoding, sequential decoding, iterative decoding, the Viterbi algorithm, the Bahl-Cocke-Jelinek-Raviv (BCJR) algorithm, the Fano algorithm, the stack algorithm, the creeper algorithm, turbo decoding, and/or suboptimal versions of these approaches (such as sliding window decoding, list decoding, etc.).

In some examples, e.g. if a decoding approach based on a trellis representation of the code such as the Viterbi algorithm is used, determining the first metric may be associated with a probability of a particular state transition conditional on the code word segment of the received first code word.

The first metric may, for example, be a Hamming distance or a Euclidean distance between the code word segment of the received first code word and a code word segment corresponding to the first message segment content, e.g. a code word segment of a branch in a trellis representation of the code. Alternatively, the first metric may be the soft values achieved after the iterations of a turbo decoder, or any other suitable metric.

The methods according to the present invention is suitable for implementation with aid of processing means, such as computers and/or processors, especially for the case where the signal processor 102 demonstrated above with reference to FIG. 1 comprises a processor handling the operations demonstrated herein. Therefore, there is provided a computer program, comprising instructions arranged to cause such processing means, processor, or computer to perform the steps of any of the methods according to any of the embodiments described with reference to FIGS. 8 and 9, and with option to perform forming and evaluation of hypotheses as described with reference to FIG. 10. The computer program preferably comprises program code which is stored on a computer readable medium 1100, as illustrated in FIG. 11, which can be loaded and executed by processing means, processor, or computer 1102 to cause it to perform the methods, respectively, according to embodiments of the present invention, preferably as any of the embodiments described with reference to FIGS. 8 and 9, and FIG. 10. The computer 1102 and computer program product 1100 can be arranged to execute the program code sequentially where actions of the any of the methods are performed stepwise, or on a real-time basis as discussed above. The processing means, processor, or computer 1102 is preferably what normally is referred to as an embedded system.

Thus, the depicted computer readable medium 1100 and computer 1102 in FIG. 11 should be construed to be for illustrative purposes only to provide understanding of the principle, and not to be construed as any direct illustration of the elements.

1. An electronic transceiver device arranged to operate in a cellular communication system, where the cellular communication system has a network node arranged to transmit control information by sweeping a cell with multiple consecutive beams where each beam covers a part of the cell and repeats at least a part of the control information, wherein the electronic transceiver device comprises:
a receiver arranged to receive signals from the network node, wherein the receiver is configured to receive a first signal from a first beam and a second signal from a second beam of the beams provided by the network node;
a memory arranged to store at least information received in the first signal; and
a signal processor arranged to
form hypotheses of differences in the received information of the first and second signals for soft-combining the information of the first and second signals; and
upon a hypothesis indicating successful soft-combining of the first and the second signals, decode control information carried by the first and second signals.

2. The electronic transceiver device of claim 1, wherein the signal processor is arranged to, prior forming the hypotheses, decode control signals carried by any of the first and second signals, and wherein upon successful decoding of the control signals carried by any of the first and second signals, the signal processor is arranged to omit forming the hypotheses, and upon unsuccessful decoding of the control signals carried by any of the first and second signals, the signal processor is arranged to proceed with forming the hypotheses, the soft-combining of signals, and the decoding of control information.

3. The electronic transceiver device of claim 2, wherein determination of successful decoding is based on a check sum.

4. The electronic transceiver device of claim 1, wherein the multiple consecutive beams are repeatedly sweeping the cell, and the memory and signal processor are arranged to only consider beams within a last repetition cycle.

5. The electronic transceiver device of claim 1, wherein the sweeping is performed in one plane*, wherein the memory and signal processor are arranged to consider the first and second signals from two mutually adjacent beams.

6. The electronic transceiver device of claim 1, wherein the sweeping is performed in two planes*, wherein the memory is arranged to store information received in a plurality of signals, and the signal processor is arranged to form hypotheses of differences in the information received in the plurality of signals, respectively, and second signal for soft-combining the information of at least one of the plurality of signals and second signal.

7. The electronic transceiver device of claim 1, wherein the signal processor is arranged to form the hypotheses by being configured to:
hypothesize a difference between the first signal or one of the plurality of signals and the second signal, the difference being one or more symbols of the first signal or one of the plurality of signals differing from corresponding symbols of the second signal;
decode the first signal or one of the plurality of signals by, for each code word segment of a received first code word of the first signal or one of the plurality of signals:
determining a first metric associated with a probability that the code word segment of the received first code word corresponds to a first signal segment content;
determining a second metric associated with a probability that the code word segment of a received second code word of the second signal corresponds to the first signal segment content conditional on the difference between the first signal or one of the plurality of signals and the second signal; and
determining a decision metric from the first and second metrics; and
select, for the first signal or one of the plurality of signals, the first signal segment content or a second signal segment content, or for the second signal the first signal segment content or the second signal segment content, based on the decision metric, for the soft-combining, wherein a determination whether the soft-combining is successful is based on the decision metric.

8. The electronic transceiver device of claim 1, wherein the signal processor is arranged to form the hypotheses of differences in the received information of the first and second signals for soft-combining the information of the first and second signals by being arranged to invert and soft-combine the information according to a hypothesis dependent pattern**.

9. A method of an electronic transceiver device arranged to operate in a cellular communication system, where the cellular communication system has a network node arranged to transmit control information by sweeping a cell with multiple consecutive beams where each beam covers a part of the cell and repeats at least a part of the control information, wherein the method comprises:
receiving signals from the network node, including receiving a first signal from a first beam and receiving a second signal from a second beam of the beams provided by the network node;
storing at least information received in the first signal;
forming hypotheses of differences in the received information of the first and second signals for soft-combining the information of the first and second signals; and
decoding, upon a hypothesis indicating successful soft-combining of the first and the second signals, control information carried by the first and second signals.

10. The method of claim 9, comprising, prior to forming the hypotheses, decoding control signals carried by any of the first and second signals, and wherein upon successful decoding of the control signals carried by any of the first and second signals, omitting the forming of the hypotheses, and upon unsuccessful decoding of the control signals carried by any of the first and second signals, proceeding with forming the hypotheses, the soft-combining, and the decoding.

11. The method of claim 10, wherein determination of successful decoding is based on a check sum.

12. The method of claim 9, wherein the multiple consecutive beams are repeatedly sweeping the cell, and the first and the second signals are included in beams within a last repetition cycle.

13. The method of claim 9, wherein the sweeping is performed in one plane, and the first and second signals emanate from two mutually adjacent beams.

14. The method of claim 9, wherein the sweeping is performed in two planes, wherein the storing includes storing information received in a plurality of signals, and the forming of hypotheses includes forming of hypotheses of differences in the information received in the plurality of signals, respectively, and the second signal for soft-combining the information of at least one of the plurality of signals and second signal.

15. The method of claim 9, wherein the forming of hypotheses comprising:
hypothesizing a difference between the first signal or one of the plurality of signals and the second signal, the difference being one or more symbols of the first signal or one of the plurality of signals differing from corresponding symbols of the second signal;
decoding the first signal or one of the plurality of signals by, for each code word segment of a received first code word of the first signal or one of the plurality of signals:
determining a first metric associated with a probability that the code word segment of the received first code word corresponds to a first signal segment content;
determining a second metric associated with a probability that the code word segment of a received second code word of the second signal corresponds to the first signal segment content conditional on the difference between the first signal or one of the plurality of signals and the second signal; and
determining a decision metric from the first and second metrics; and
selecting, for the first signal or one of the plurality of signals, the first signal segment content or a second signal segment content, or for the second signal the first signal segment content or the second signal segment content, based on the decision metric, for the soft-combining, wherein a determination whether the soft-combining is successful is based on the decision metric.

16. The method of claim 9, wherein the forming of the hypotheses of differences in the received information of the first and second signals for soft-combining the information of the first and second signals comprises inverting and soft-combining the information according to a hypothesis dependent pattern**.

17. A nontransitory computer readable storage medium comprising instructions which, when executed on a processor of an electronic transceiver device, causes the electronic transceiver device to perform a method, wherein the transceiver device is arranged to operate in a cellular communication system, wherein the cellular communication system has a network node arranged to transmit control information by sweeping a cell with multiple consecutive beams where each beam covers a part of the cell and repeats at least a part of the control information, and wherein the method comprises:
receiving signals from the network node, including receiving a first signal from a first beam and receiving a second signal from a second beam of the beams provided by the network node;
storing at least information received in the first signal;
forming hypotheses of differences in the received information of the first and second signals for soft-combining the information of the first and second signals; and
decoding, upon a hypothesis indicating successful soft-combining of the first and the second signals, control information carried by the first and second signals.
